(19) United States
(12) Patent Application Publication
(10) Pub. No.: US 2004/0132954 A1
(43) Pub. Date: Jul. 8, 2004

(54) Mixture of substances for the uv-stabilisation of synthetic materials and the production thereof

(76) Inventors: Hauke Malz, Diepholz (DE); Johann Diedrich Brand, Lemforde (DE); Thomas Flug, Wagenfeld (DE); Christa Hackl, Bad Essen (DE)

Correspondence Address: Basf Corporation, Patent Department, 1609 Biddle Avenue, Wyandotte, MI, 48192, US

(21) Appl. No.: 10/474,926

(22) PCT Filed: Apr. 25, 2002
(86) PCT No.: PCT/EP02/04597

(30) Foreign Application Priority Data
Apr. 27, 2001 (DE) 10120838.3

(51) Int. Cl. C08G 18/00

(52) U.S. Cl. 528/59; 528/61

(57) ABSTRACT

The invention relates to a mixture of substances with a number average molecular weight of between 500 and 15000 g/mol, whereby the number average molecular weight is different from the weight average molecular weight which is obtainable by A) reacting UV-absorbers, or a mixture of UV-absorbers and stabilisers for synthetic materials with dioles, whereby at least one section of the UV-absorbers or the stabilisers comprise at least two groups which react against dioles, and/or B) reacting UV-absorbers, or a mixture of UV-absorbers and stabilisers for thermoplastic synthetic materials with a polyol.

The invention relates to a substance mixture for the UV stabilization of plastics, in particular of thermoplastic polyurethanes, with a number-average molar mass of from 500 to 15 000 g/mol, where the number-average molar mass is not identical with the weight-average molar mass, obtainable by A) reacting UV absorbers with diols and/or B) reacting UV absorbers with a polyol, and also to the preparation of the substance mixture and to its use for the preparation and use of polyurethanes.

Thermoplastic polyurethane (TPU) is generally stabilized using heat stabilizers and UV stabilizers, in order to minimize the fall-off of mechanical properties and the discoloration of the products due to oxidative degradation. One group of UV stabilizers is represented by UV absorbers which absorb the high-energy UV light and dissipate this energy. Examples of familiar UV absorbers used in industry are those in the group consisting of the cinnamic esters, the diphenylcyanoacrylates, the diarylbutadienes, and the benzotriazoles.

WO 96/15184 describes the use of arylacrylic esters as light stabilizers and stabilizers for non-living organic material.

DE-A-34 24 555 describes the preparation and use of malonic polyesters and of malonic polyester amides for the UV-stabilization of thermoplastics.

EP-A-826 725 discloses stabilized polyurethanes in which the stabilizer present comprises diglycidyl terephthalate or triglycidyl trimellitate combined with UV filters.

EP-A-698637 describes benzotriazoles substituted at the 5-position and used as UV absorbers for polyurethanes and polyureas, where appropriate combined with HALS amines as stabilizers.

Even if these currently available products by now have optimized absorption properties, they still have considerable shortcomings in their physical properties and in their compatibility with the TPU. For example, many commercially available UV absorbers are of low molar mass, with molar mass below 400 g/mol. The result is that, with the passage of time, the UV absorber volatilizes out of the plastic to be stabilized. The loss of the UV absorber from the plastic is accompanied by a loss of its protection from UV-induced degradation.

Attempts were therefore frequently made to raise the molar mass of their UV absorber by oligomerization. However, this frequently gives crystalline, low-solubility UV absorbers which migrate out from the DTU and become visible as a marked deposit on the surface, thus impairing the appearance of the product and causing loss of absorption properties, since the active group is eliminated.

It is an object of the present invention, therefore, to develop a means for UV-stabilization of plastics which can be incorporated into plastics, preferably into thermoplastics, in particular into thermoplastic polyurethanes, in a manner which is simple, controllable, homogeneous, and reproducible. In addition, and in particular in thermoplastic polyurethanes, this composition should bre substantially free from fogging, migration, and exudation at all temperatures, i.e. show markedly less loss of UV-absorbing component by evaporation from the TPU, and also markedly less formation of deposit on the surface of the thermoplastic polyurethanes. A further object of the invention was to provide a composition which, besides providing UV-stabilization, also provides heat-stabilization of plastics, in particular of thermoplastic polyurethanes, and the intention here is that the two stabilizing actions be ideally balanced with respect to one another in order to achieve particularly effective action in respect of both properties while at the same time using very little material.

We have found that this object is achieved by means of a substance mixture for UV-stabilization, preferably amorphous or liquid and with a number-average molar mass of from 500 to 15 000 g/mol, where the number-average molar mass is not identical with the weight-average molar mass. These substances of the mixture have non-uniform molar mass and are present with a distribution of molar mass. It has been found that substance mixtures of this type can be incorporated into thermoplastics with unexpected advantages for UV-stabilization.

The invention therefore provides a substance mixture (I) with a number-average molar mass of from 500 to 15 000 g/mol, where the number-average molar mass is not identical with the weight-average molar mass, obtainable by

A) reacting UV absorbers (II), or a mixture of UV absorbers (II) and stabilizers (III) for plastics, with diols (IV), where at least some of the UV absorbers (II) or of the stabilizers (III) have at least two groups reactive toward diols,

and/or

B) reacting UV absorbers (II), or a mixture of UV absorbers (II) and stabilizers (III) for thermoplastics, with a polyol (V).

The invention further provides a process for preparing the substance mixture of the invention, which comprises reacting UV absorbers (II), or a mixture of UV absorbers (II) and stabilizers (III), with diols (IV), where at least some of the UV absorbers (II) or of the stabilizers (III) have at least two groups reactive toward diols (IV), and a process wherein a UV absorber (II), or a mixture of UV absorbers (II) and stabilizers (III), is reacted with a polyol (V), where the polyol preferably has a number-average molar mass of from 75 F g/mol to 250 F g/mol, and F is the number of functional groups in the polyol.

The invention further provides the use of the substance mixture of the invention for the UV-stabilization of plastics, preferably of thermoplastics, particularly preferably of thermoplastic polyurethanes.

The invention also provides a process for preparing polyurethanes, preferably thermoplastic polyurethanes, using the substance mixture of the invention for UV-stabilization.

Finally, the invention provides polyurethanes which can be prepared by the process described above.

The terms substance mixture (I), UV-absorber (II), stabilizer (III), diol (IV), and polyol (V) will be explained below.

For the purposes of the present invention, UV absorbers (II) are generally compounds with capability to absorb ultraviolet radiation, preferably via radiationless deactivation. Examples of these are benzophenone derivatives, 3-phenyl-substituted acrylates, preferably having cyano groups in the 2-position, diarylbutadiene derivatives, benzotriazole derivatives, salicylates, organic nickel complexes, and naturally occurring UV-absorbing substances, such as umbelliferone.

The UV absorbers (II) of the present invention have at least one group which is reactive toward the diol (IV) or toward the polyol (V), for example a carboxy, ester, thioester, or amide group, and via which covalent bonding to the diol (IV) or to the polyol (V) can take place.

The UV absorbers (II) used are preferably compounds of the formulae II.1 to II.5

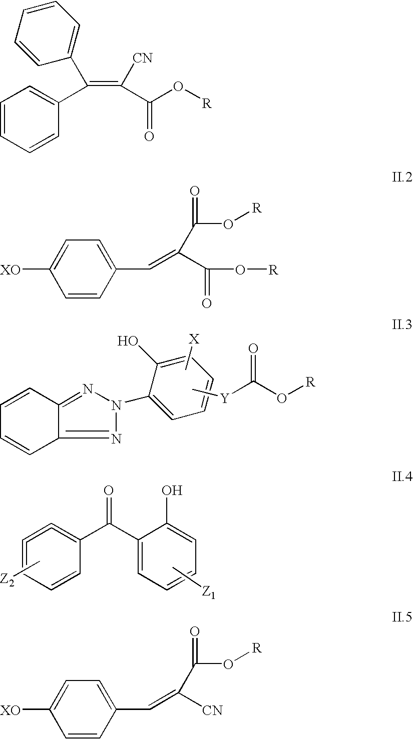

where X is a hydrogen atom, a linear or branched C₁-C₂₀-alkyl radical, a C₅-C₁₂-cycloalkyl radical, where appropriate mono-, di-, or trisubstituted with a C₁-C₂₀-alkyl radical or phenylalkyl radical, or is a hindered amine,

R is a hydrogen atom, a linear or branched C₁-C₁₀-alkyl radical, preferably C₁-C₂-alkyl radical, or a C₁-C₁₀-alkoxyalkyl radical, or a C₁-C₁₀-alkenyl radical, and Y is a covalent bond or a linear or branched C₁-C₁₂-alkylene radical, and Z₁ and Z₂ are linear, branched, or cyclic, saturated or unsaturated hydrocarbon radicals having from 1 to 10 carbon atoms, and at least one of the radicals here preferably has substitution by a group of the formula —COOR or —CONHR, and R here is as defined above.

Particular preference is given to the use of UV stabilizers (II) of the formulae II.1 and/or II.3, in particular of the formula II.3. Other UV stabilizers (II) whose use is preferred are those disclosed in U.S. Pat. No. 5,508,025 (in particular in columns 5 and 6). Mixtures of the UV stabilizers mentioned may also be used with advantage, since these can give absorption of various regions of UV light.

For the purposes of this application, the term stabilizer (III) encompasses the well known stabilizers for thermoplastics, examples being phosphites, thio synergists, HALS compounds, quenchers, and sterically hindered phenols. The stabilizers (III) of the present invention have at least one group reactive toward the diol (IV) or toward the polyol (V), for example a carboxy, ester, thioester, or amide group, via which covalent bonding to the diol (IV) or to the polyol (V) can take place.

The stabilizers (III) whose use is preferred are sterically hindered phenols of the formula III.1

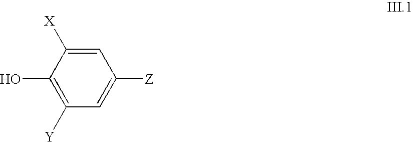

where X and Y, independently of one another, are hydrogen, or straight-chain, branched or cyclic alkyl radicals having from 1 to 12 carbon atoms, and

Z is a carboxy group bonded via a covalent bond or via a C₁-C₁₂-alkylene radical to the phenyl radical.

A compound preferably used as stabilizer (III) has the formula III.2

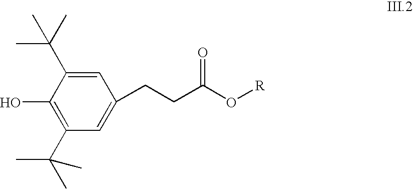

where R is a hydrogen atom or an alkyl radical having from 1 to 12 carbon atoms, preferably a methyl radical or ethyl radical.

The stabilizer (III) used may also preferably comprise hindered amine light stabilizers (HALS) of the formula III.3

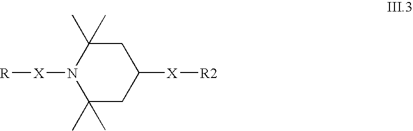

where X is a covalent bond, a nitrogen atom, an oxygen atom, an amide group, or an ester group, and R and R2, independently of one another, are a hydrogen atom or an alkyl radical having from 1 to 12 carbon atoms, and at least one of these radicals has at least one functional group, such as a carboxy group, ester group, or amide group, which permits linkage to the diol (IV) or to the polyol (V) to be made via this functional group.

It is also possible to use mixtures of various stabilizers (III), for example stabilizers having phenolic active groups and HALS amines.

For the purposes of the invention, the diols (IV) are linear or branched hydrocarbons having from 2 to 20, preferably from 2 to 12, carbon atoms, and having two functional groups selected from OH groups, preferably primary OH groups, NHR groups, where R is a hydrogen atom or an alkyl radical, SH groups, and mixtures of these groups. Examples of diols (IV) are 1,2-ethanediol, 1,3-propanediol, 1,4-butanediol, 1,5-pentanediol, 1,6-hexanediol, and diethylene glycol.

For the purposes of this invention, the polyols (V) used may comprise well known polyols, such as polyesterols, polycarbonatediols, polyetherols, polythioetherols, polyetheresterols, and/or polyether polythioetherols, preferably polyetherols, where these have at least two groups reactive toward the UV absorbers (II) and toward the stabilizers (III), i.e. preferably groups reactive toward carboxy groups, toward ester groups, and/or toward amide groups, for example hydroxyl groups and/or amino groups. The polyols (V) may have a linear or branched structure, and their molar mass, preferably number-average molar mass, is from 75×F to 251×F g/mol, more preferably from 100×F to 200×F g/mol, in particular from 100×F to 151×F g/mol, the term F representing the number of functional groups in the polyol (V). When determining the molar mass of the polyol account is to be taken of, for example, the nitrogen or the oxygen via which the polyol has been bonded to a UV absorber (II) or stabilizer (III) within an amide structure or ester structure. For the purposes of this application, the term polyol (V) does not describe a specific molecule, but something of the nature of a polyol mixture with no uniform molar mass. That is to say that the polyol (V) has a distribution of molar masses, the number-average molar mass being non-identical with the weight-average molar mass. It is preferable here for the number-average molar mass to be smaller than the weight-average molar mass, that is to say that Mw/Mn is greater than 1, and Mw/Mn is more preferably from 1.01 to 50, even more preferably from 1.1 to 15, Mw/Mn particularly preferably being from 1.1 to 5.

The polyols (V) used are preferably polyetherols and polyesterols, particularly preferably polyetherols.

Suitable polyether polyols are generally prepared by known processes, for example by anionic polymerization using alkali metal hydroxides or alkali metal alkoxides as catalysts and adding at least one starter molecule containing from 2 to 8, preferably from 2 to 6, in particular 2, reactive hydrogen atoms, or by cationic polymerization using Lewis acids or multimetal cyanide compounds as catalysts, from one or more alkylene oxides having from 2 to 4 carbon atoms in the alkylene radical. Examples of suitable alkylene oxides are tetrahydrofuran, butylene 1,2- or 2,3-oxide, styrene oxide, and preferably ethylene oxide, propylene 1,2-oxide, and tetrahydrofuran. The alkylene oxides may be used individually, alternating one after the other, or as mixtures. Examples of starter molecules which may be used are: water, organic dicarboxylic acids, such as succinic acid, adipic acid, phthalic acid and terephthalic acid, alkanolamines, and multifunctional alcohols, in particular those with a functionality of 2 or higher, such as ethanediol, 1,2- and 1,3-propanediol, diethylene glycol, dipropylene glycol, 1,4-butanediol, 1,6-hexanediol, glycerol, trimethylolpropane, pentaerythritol, and sucrose.

One way of preparing suitable polyester polyols is from organic dicarboxylic acids having from 2 to 12 carbon atoms, preferably aliphatic dicarboxylic acids having from 4 to 6 carbon atoms, and multifunctional alcohols, preferably diols, having from 2 to 12 carbon atoms, preferably from 2 to 6 carbon atoms.

Reaction of the UV absorbers (II) and, where appropriate, of the stabilizers (III) with diols (IV) and/or with polyols (IV) gives the substance mixture (I) of the invention, this being a mixture of compounds with non-uniform molar mass.

For the purposes of this application, the term substance mixture (I) encompasses two types of compounds with different structures:

A) The term substance mixture (I) encompasses compounds obtainable by reacting UV absorbers (II) or a mixture of UV absorbers (II) and stabilizers for thermoplastics (III), with diols (IV), where at least part of the UV absorbers (II) or of the stabilizers (III) has at least two groups reactive toward diols (IV). Suitable reactive groups, as described above, are generally carboxylic acid groups, ester groups, thioester groups, and amide groups. Ester groups are preferred. The bonding of the UV absorbers (II) and, where appropriate, of the stabilizers (III), to the diol (IV) may therefore take place through well-known esterification reactions, transesterification reactions, and/or amidation reactions.

The reaction as mentioned above would give high-molecular-weight compounds if components (II) and (III) having two reactive groups are reacted stoichiometrically with diols (IV). However, desirable compounds in the substance mixture are those which have a number-average molar mass of <15 000 g/mol, preferably <10 000 g/mol, particularly preferably <3 000 g/mol, and the molar mass therefore has to be limited. One way of achieving this is to use non-stoichiometry of components (II) and, where appropriate, (III) and (IV), or addition of components (II) and, where appropriate, (III) which have only one group reactive toward the diol (IV). If non-stoichiometry of the components is selected in order to regulate molar mass, it is preferably selected in such a way that there is an excess of equivalents of component II or of a mixture of components II over component IV. The selection of the ratio preferably minimizes the number of free aliphatic OH groups in the substance mixture. It is also possible for a conventional chain-regulating additive, such as a monool, or a monoester, to be added. Preferred chain regulators are described below.

B) The term substance mixture (I) encompasses compounds obtainable by reacting UV absorbers (II) or a mixture of UV absorbers (II) and stabilizers for thermoplastics (III), with a polyol (V), the polyol (V) preferably having a number-average molar mass of from 75 F g/mol tos 250 F g/mol, F being the number of functional groups in the polyol. Here, too, the bonding of the UV absorber (II) or of the stabilizer (III) to the polyol (V) may be given by ester groups, amide groups, and/or thioester groups, for example, preferably ester groups. The reaction as mentioned above would give high-molecular-weight compounds, or even crosslinking, if components (II) and (III) having two reactive groups are reacted stoichiometrically with polyols (V). However, compounds desirable in the substance mixture are those which have a number-average molar mass of <15 000 g/mol, preferably <10 000 g/mol, particularly preferably <3 000 g/mol, and the molar mass therefore has to be limited. One way of achieving this is to use non-stoichiometry of components (II) and, where appropriate, (III) and (V), or addition of components (II) and, where appropriate, (III) which have only one group reactive toward the polyol (V). If non-stoichiometry of the components is selected in order to regulate molar mass, it is preferably selected in such a way that there is an excess of equivalents of component II or of a mixture of components II over component V. The selection of the ratio preferably minimizes the number of free aliphatic OH groups in the substance mixture. It is also possible for a conventional chain-regulating additive, such as a monool, or a monoester, to be added. Preferred chain regulators are described below.

The substance mixture of the invention also encompasses a mixture of the types of compound set out under A) and B). A mixture of this type may also be prepared from the starting materials in situ.

In both cases, the reaction conditions for preparing the substance mixture (I) are preferably selected in such a way that the product of the reaction has very few, preferably no, free reactive, i.e. aliphatic, OH groups, since these react with the isocyanate groups or urethane groups during processing in a thermoplastic urethane, and thus can cause molar mass degradation of the polymer. In one preferred embodiment, the substance mixture (I) has an aliphatic hydroxyl value (OHV) below 20, preferably below 10, particularly preferably below 5, and aliphatic OHV means here that it is only aliphatic OH groups which are taken into account when determining the OHV, and not the free OH groups of the sterically hindered phenols. In one preferred embodiment, there is therefore an excess of equivalents of UV absorber (II) and, where appropriate, stabilizer (III) over diol (IV) or polyol (V).

To prepare the substance mixtures (I), use may be made of UV absorbers (II), or a mixture of UV absorbers (II) and stabilizers (III). In one preferred embodiment, the ratio by weight of absorber (II) to stabilizer (III) in this mixture is from 10:90 to 99:1, preferably from 20:80 to 80:20, and particularly preferably from 40:60 to 80:20.

The substance mixtures (I) of the invention comprise compounds with different molar masses, i.e. these compounds have a distribution of molar masses in the substance mixture (I) of the invention, in such a way that the substance mixture (I) of the invention has an average molar mass (Mn) of from 500 to 15 000 g/mol, preferably from 600 to 10 000 g/mol, particularly preferbaly from 600 to 3 000 g/mol, and in such a way that the number-average molar mass (Mn) is not equal to the weight-average molar mass (Mw). It is preferable that in the substance mixture of the invention the number-average molar mass is below the weight-average molar mass, i.e. Mw/Mn>1, Mw/Mn more preferably being from 1.01 to 50, still more preferably from 1.1 to 15, and Mw/Mn particularly preferably being from 1.1 to 5.

It is important to keep to the molar mass ranges described above for the substance mixture of the invention, since within this range it is possible to achieve unexpectedly advantageous homogenization and compatibility of the substance mixture with the thermoplastic. This molar mass moreover ensures an advantageous ratio between high-molecular-weight low-volatility constituents and low-molecular-weight constituents which diffuse rapidly and can therefore become homogeneously distributed within the sample.

The substance mixtures of the invention do not crystallize, but are preferably liquid or amorphous. If they are liquid, their viscosity at room temperature (25° C.) is generally η=from 10⁻²-10² Pas, preferably η=from 10⁻¹-10¹ Pas, measured with a rotary viscometer using cone and plate geometry.

The substance mixtures of the invention may be used for stabilization, preferably with respect to UV radiation, in any of the known plastics, such as acrylonitrile-butadiene-styrene copolymers (ABS), ASA, SAN, polyethylene, polypropylene, EPM, EPDM, PVC, acrylate rubber, polyester, polyoxymethylene (POM), polyamide (PA), PC (polycarbonate), and/or compact or cellular polyurethanes, e.g. flexible, rigid, or integral foams, cast elastomers, RIM systems, and thermoplastic polyurethanes. The substance mixture are also suitable for stabilizing organic compounds in general, for example organic compounds with a molar mass of from 50 to 100 000 g/mol, for example polyesters, polyethers, polyesterols, or polyetherols. The substance mixtures of the present invention are preferably used in thermoplastic polyurethanes.

Incorporation into the plastics mentioned may take place during preparation or during processing. The substance mixtures of the invention may also be used as a concentrate.

The amount of the substance mixtures of the invention preferably present in the plastics, in particular the PTUs, is from 0.01 to 10% by weight, particularly preferably from 0.1 to 3% by weight, in particular from 0.2 to 1.5% by weight, based in each case on the weight of the thermoplastic.

In addition to the stabilizers of the invention, other well-known stabilizers may be used in the plastics, for example phosphites, thiosynergists, HALS compounds, UV absorbers, quenchers, or sterically hindered phenols. EP-A-698637 (page 6, line 13 to page 9, line 33) describes examples of these known stabilizers.

Processes for preparing polyurethanes, in particular TPUs, are well known. For example, polyurethanes, preferably TPUs, may be prepared by reacting (a) isocyanates with (b) compounds reactive toward isocyanates and having a molar mass of from 500 to 10 000, and, where appropriate, (c) chain extenders with a molar mass of from 50 to 499, where appropriate in the presence of (d) catalysts and/or (e) conventional auxiliaries and/or additives, and this reaction may be carried out in the presence of the inhibitors of the invention. Component (e) also includes hydrolysis stabilizers, such as polymers or low-molecular-weight carbodiimides.

The starting components and processes for preparing the preferred polyurethanes will be described by way of example below. The components (a), (b), and also, where appropriate, (c), (d), and/or (e) usually used when preparing the polyurethanes will be described below by way of example:

a) The organic isocyanates (a) used may be well known aliphatic, cycloaliphatic, araliphatic, and/or aromatic isocyanates, such as tri-, tetra-, penta-, hexa-, hepta-, and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methyl-2,4- and/or -2,6-cyclohexane diisocyanate, and/or dicyclohexylmethane 4,4′-, 2,4′-, or 2,2′-diisocyanate, diphenylmethane 2,2′-, 2,4′-, and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethyldiphenyl diisocyanate, 1,2-diphenylethane diisocyanate, and/or phenylene diisocyanate.

b) The compounds (b) which may be used and are reactive toward isocyanates are the well-known compounds reactive toward isocyanates, for example polyesterols, polyetherols, and/or polycarbonatediols, these usually being brought together under the term “polyol”, with molar masses of from 500 to 8 000, preferably from 600 to 6 000, in particular from 800 to 4 000, and preferably with an average functionality of from 1.8 to 2.3, preferably from 1.9 to 2.2, in particular 2. It is preferable to use polyether polyols, such as those based on well-known starter substances and on conventional alkylene oxides, e.g. ethylene oxide, propylene oxide, and/or butylene oxide, preferably polyetherols based on propylene 1,2-oxide and ethylene oxide, and in particular polyoxytetramethylene glycols. The polyetherols have the advantage of higher hydrolysis resistance than polyesterols.

c) The chain extenders (c) used may comprise well-known aliphatic, araliphatic, aromatic, and/or cycloaliphatic compounds with a molar mass of from 50 to 499, preferably bifunctional compounds, such as diamines and/or alkanediols having from 2 to 10 carbon atoms in the alkylene radical, in particular 1,4-butanediol, 1,6-hexanediol, and/or di-, tri-, tetra-, penta-, hexa-, hepta-, octa-, nona-, and/or decaalkylene glycols where the alkylene radical has from 3 to 8 carbon atoms, and preferably corresponding oligo- and/or polypropylene glycols. Mixtures of the chain extenders may also be used here.

d) Suitable catalysts which in particular accelerate the reaction between the NCO groups of the diisocyanates (a) and the hydroxyl groups of structural components (b) and (c) are the tertiary amines which are conventional and known in the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane, and the like, and also in particular organic metal compounds, such as titanic esters, iron compounds, e.g. iron(III) acetylacetonate, tin compounds, e.g. tin diacetate, tin dioctoate, tin dilaurate, or the dialkyltin salts of aliphatic carboxylic acids, for example dibutyltin diacetate, dibutyltin dilaurate, or the like. The amounts usually used of the catalysts are from 0.0001 to 0.1 parts by weight per 100 parts by weight of polyhydroxy compound (b).

e) Besides catalysts (d), conventional auxiliaries and/or additives (e) may also be added to the structural components (a) to (c). Examples which may be mentioned are surface-active substances, fillers, flame retardants, nucleating agents, antioxidants, lubricants, mold-release agents, dyes, and pigments, and, where appropriate in addition to the inhibitors of the invention, other stabilizers, e.g. with respect to hydrolysis, light; heat, or discoloration, and inorganic and/or organic fillers, reinforcing agents, and plasticizers. In one preferred embodiment, component (e) also includes hydrolysis stabilizers, such as polymers or low-molecular-weight carbodiimides.

Besides the components a) and b) mentioned and, where appropriate, c), d), and e), use may also be made of chain regulators, usually with a molar mass of from 31 to 499. These chain regulators are compounds which have only one functional group reactive toward isocyanates, e.g. monofunctional alcohols, monofunctional amines, and/or monofunctional polyols. Such chain regulators can adjust flow performance as desired, in particular in the case of TPUs. Use may generally be made of from 0 to 5 parts by weight, preferably from 0.1 to 1 part by weight, of chain regulators, based on 100 parts by weight of component b). The chain regulators are defined as part of component c).

Further details concerning the abovementioned auxiliaries and additives may be found in the technical literature.

All of the molar masses mentioned in this specification have the unit [g/mol].

To adjust the hardness of the TPUs, the molar ratios of structural components (b) and (c) may be varied relatively widely. Molar ratios which have proven successful, expressed in terms of component (b) to the total amount to be used as chain extenders (c), are from 10:1 to 1:10, in particular from 1:1 to 1:4, the hardness of the TPUs rising with increasing content of (c).

It is preferable to include chain extenders (c) in the preparation of the TPUs.

The usual indices may be used in the reaction, preferably an index of from 60 to 120, particularly preferably an index of from 80 to 110. The index is designed as the ratio of the total number of isocyanate groups used in the reaction in component (a) to the number of groups reactive toward isocyanates, i.e. to the active hydrogens, in components (b) and (c). If the index is 100, components (b) and (c) have one active hydrogen atom, i.e. one function reactive toward isocyanates, for each isocyanate group in component (a). If the index is above 100, there are more isocyanate groups than OH groups present.

The TPUs may be prepared by known processes either continuously, for example using reactive extruders or using the belt process, by the one-shot or the prepolymer method, or batchwise by the known prepolymer process. In these processes, the components (a), (b), and, where appropriate, (c), (d), and/or (e) entering into the reaction may be mixed with one another in succession or simultaneously, and the reaction then begins immediately.

In the extruder process, the structural components (a), (b), and, where appropriate, (c), (d), and/or (e) are introduced into the extruder individually or as a mixture, and reacted, e.g. from 100 to 280° C., preferably from 140 to 250° C., and the resultant TPU is extruded, cooled, and pelletized.

Conventional processes, e.g. injection molding or extrusion, are used to process the TPUs prepared according to the invention to give the desired films, moldings, rollers, fibers, coverings within automobiles, tubings, cable plugs, folding bellows, drag cables, cable sheathing, gaskets, drive belts, or attenuating elements, usually from pellets or powders.

The thermoplastic polyurethanes which can be prepared by the processes of the invention, preferably the films, moldings, shoe soles, rollers, fibers, coverings within automobiles, wiper blades, tubing, cable plugs, folding bellows, drag cables, cable sheathing, gaskets, drive belts, or attenuating elements, have the advantages described at the outset.

The examples below are intended to illustrate the advantages of the invention.

Preparation of Substance Mixtures (I):

### EXAMPLE 1

50 g of PTHF 250 (MM:228.51 g/mol; 0.2188 mol) were placed in a 250 ml flask with 54.76 g of dimethyl 4-methoxybenzylidene malonate (Sanduvor® PR25) (250.25 g/mol; 0.2188 mol) and 50 ppm of dimethyltin dilaurate (from 20% strength solution in dioctyl adipate). The flask was flushed with nitrogen and then heated to 170° C., with stirring. Passage of nitrogen through the solution was continued. The resultant methanol was removed by freezing in a cold trap (liquid nitrogen). Conversion was determined by GPC. After 13 h/170° C. it was 98.6%.

### EXAMPLE 2

50 g of PTHF 250 (MM:228.51 g/mol; 0.2188 mol) were placed in a 250 ml flask with 54.76 g of dimethyl 4-methoxybenzylidene malonate (250.25 g/mol; 0.2188 mol), and 1 g of methyl 3-(3,5-di-tert-butyl-4-hydroxyphenyl)propionate (292 g/mol; 3.4 mmol) and 50 ppm of dimethyltin dilaurate (from 20% strength solution in DOA). The flask was flushed with nitrogen and then heated to 170° C., with stirring. Passage of nitrogen through the solution was continued. The resultant methanol was removed by freezing in a cold trap (liquid nitrogen) (14.0 g). Conversion after 13 h/170° C. was 97.9%.

### EXAMPLE 3

50 g of PTHF 250 (MM:228.51 g/mol; 0.2188 mol) were placed in a 250 ml flask with 63.98 g of methyl 3-(3,5-di-tert-butyl-4-hydroxyphenyl)propionate (0.2188 mol) and 50 ppm of dimethyltin dilaurate (from 20% strength solution in DOA), and the mixture is heated at 170° C. for 6 h under a continuous stream of nitrogen. In the second step, 27.38 g of dimethyl 4-methoxybenzyldenemalonate (250.25 g/mol; 0.11 mol) were added to the reaction solution and stirred at 170° C. for 13 h, with nitrogen flushing. The resultant methanol was removed by freezing in a cold trap (liquid nitrogen).

Conversion after 16 h/170° C. was 98.4% (determined by GPC).

### EXAMPLE 4

30 g of PTHF 250 (MM:228.51 g/mol; 0.1313 mol) were placed in a 250 ml flask with 71.28 g of ethyl 2-cyano-3,3-diphenylacrylate (Uvinul® 3035) (277 g/mol; 0.2573 mol) and 1 g of methyl 3-(3,5-di-tert-butyl-4-hydroxyphenyl)propionate (292 g/mol; 3.4 mmol), and also 50 ppm of dimethyltin dilaurate (from 20% strength solution in DOA). The flask was flushed with nitrogen and then heated to 170° C., with stirring and continuous nitrogen flushing. The resultant methanol and, respectively, ethanol were removed by freezing in a cold trap (liquid nitrogen).

Conversion after 12 h/170° C. was 97.8%.

### EXAMPLE 5

50 g of PTHF 250 (MM:226.85 g/mol; 0.2204 mol) were placed in a 250 ml flask with 52.4 g of dimethyl 4-methoxybenzylidenemalonate (250.25 g/mol; 0.20939 mol) and 6.11 g of ethyl 2-cyano-3,3-diphenylacrylate (277 g/mol; 0.022057 mol), and also 50 ppm of dimethyltin dilaurate (from a 20% strength solution in DOA). The flask was flushed with nitrogen and then heated to 170° C., with stirring and nitrogen flushing. Passage of nitrogen through the solution was continued. The resulting methanol and, respectively, ethanol were removed in a cold trap (liquid nitrogen).

Conversion after 13 h/170° C. was 98.7%.

### EXAMPLE 6

40 g of ethyl 3(3-(2H-benzotriazol-2-yl)-5-tert-butyl-4-hydroxyphenylpropionate (108.8 mmol) were placed in a 100 ml flask with 11.2 g of (54.4 mmol) of polyethylene glycol, and also 100 ppm of dimethyltin dilaurate (from a 20% strength solution DOA), and then reacted at 140° C. for 7 h under a continuous stream of nitrogen. The resultant ethanol was removed by freezing in a cold trap (liquid nitrogen).

The conversion after 7 h was 94%.

### EXAMPLE 7

50 g of Pluriol® E 200 (MM:201.83 g/mol; 0.2477 mol) were placed in a 250 ml flask with 61.99 g of dimethyl 4-methoxybenzylidenemalonate (250.25 g/mol; 0.2477 mol). The mixture was heated to 160° C., with stirring and nitrogen flushing. The methanol produced during the reaction was removed by freezing in a cold trap.

Conversion after 6 h/160° C. was 99.2%.

### EXAMPLE 8

11.81 g of 1,6-hexanediol (MM: 118.18 g/mol; 0.0999 mol) were placed in a 250 ml flask with 25 g of Sanduvor® PR 25 (205.25 g/mol; 0.0999 mol) and 50 ppm of dimethyltin dilaurate. The mixture was heated up to 170° C., with stirring and nitrogen flushing. The resultant methanol was removed by freezing in a cold trap (with liquid nitrogen).

Conversion after 13 h/170° C. was 98.6%.

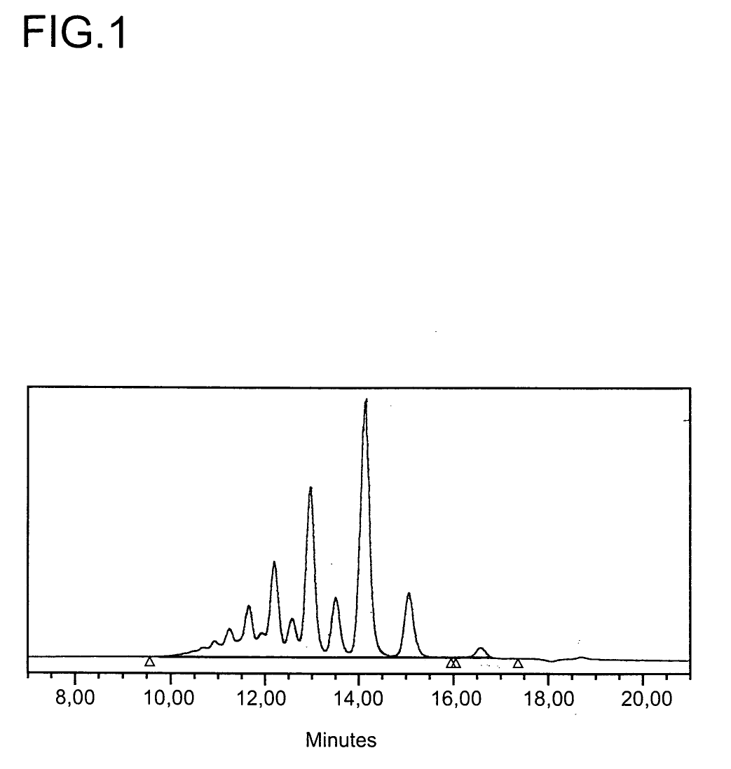

FIG. 1 shows the results of a size-exclusion chromatography study on the compound of the invention. It is clear that this is a mixture of a variety of individual compounds.

### EXAMPLE 9

25 g of Pluriol® E 200 (MM:201.83 g/mol; 0.1239 mol) were placed in a 250 ml flask with 68.62 g of ethyl 2-cyano-3,3-diphenylacrylate (277 g/mol; 0.2477 mol) and 0.047 g of potassium methoxide (500 ppm). The mixture was heated to 160° C., with stirring and nitrogen flushing. The resultant ethanol was removed by freezing in a cold trap (with liquid nitrogen).

Conversion after 7 h/160° C. was 94.3%.

Preparation of TPU Stabilized with Substance Mixtures (I)

### EXAMPLE 10

1 000 g of PTHF 1000 were melted at 45° C. in a 2 l round-bottomed flask. 8 g of Irganoxo® 1010 and 8 g Irganoxo® 1098, and also 125 g of butanediol, were then added, with stirring. Table 1 gives the amount and nature of the UV absorbers also metered in. The solution was heated to 80° C. in a 2 l tin plate bucket, with stirring, and then 600 g of 4,4′-MDI were added and stirred until the solution was homogeneous. The TPU was then poured into a flat tray in which the product was annealed in a heated cabinet at 100° C. for 24 h.

TABLE 1

| Example | UV Absorber | Amount |
|---|---|---|
| 10-1 (Comparison) | — | — |
| 10-2 | Example 1 | 8 g |
| 10-3 | Example 3 | 8 g |
| 10-4 | Example 4 | 8 g |
| 10-5 | Example 6 | 8 g |
| 10-6 (Comparison) | Uvinul ® 3030 | 8 g |

UV-Stabilization Action of the Novel Stabilizers

### EXAMPLE 11

The thermoplastic polyurethanes from Example 10 were weathered to DIN 75202. Table 2 shows the growth of the Yellowness Index on weathering. Compared with specimen 10-1, all of the specimens equipped with UV absorbers exhibit a lower level of yellowing.

TABLE 2

| | |
|---|---|
| Experiment | Yellowness Index YI |

| No. | 0 - Specimen | 150 h | 300 h | 500 h |
|---|---|---|---|---|
| 10.1 | 14.52 | 32.2 | 49.3 | 60.73 |
| 10.2 | 6.62 | 22.57 | 38.8 | 49.9 |
| 10.3 | 3.34 | 13.89 | 30.48 | 39.43 |
| 10.4 | 6.22 | 20.86 | 31.72 | 44.29 |
| 10.5 | 9.97 | 17.08 | 26.4 | 33.09 |

Synthesis of a Stabilizer Concentrate

### EXAMPLE 12

A concentrate based on Elastollan® 1185 A polyether TPU was prepared using the stabilizer from Example 6. This contains no free hydroxyl groups. To this end, 54 g of polyether TPU were melted in a batch kneader starting at 200° C. 6 g of UV absorber from Example 6 were metered into the melt within a period of 25 minutes. The resultant drop in the viscosity of the melt was not so marked as in the preceding example, and therefore the temperature of the kneader merely had to be reduced to 170° C. to permit incorporation.

The GPC analysis of the molar mass of the concentrate gave a weight-average molar mass M_{w} of 79 000 g/mol.

For comparison, a concentrate based on Elastollan® 1185 A polyether TPU was prepared using a commercial UV absorber, Tinuvin® 1130. To this end, 54 g of polyether TPU were melted in a batch kneader, starting at 200° C. 6 g of Tinuvin 1130 were metered into the melt within a period of 35 minutes. There was a marked resultant drop in the viscosity of the melt, and therefore the temperature of the kneader had to be lowered to 140° C. to permit incorporation of the Tinuvin® 1130. GPC analysis of the molar mass of the concentrate gave a weight-average molar mass M_{w} of 46 000 g/mol.

This example shows that processing to give concentrates is improved using the UV absorbers of the invention rather than comparable commercial UV absorbers, which lead to marked degradation of molar mass and therefore to loss of product properties.

Exudation from a Commercial Oligomeric UV Absorber

### EXAMPLE 13

An injection-molded sheet of TPU Example 10-4 of thickness 2 mm was annealed at 80° C. in a heating cabinet. Due to the good compatibility of the stabilizer, even after as much as 4 weeks there was still no formation of any deposit. For comparison, an injection-molded sheet of thickness 2 mm made from TPU of comparative example 10-6 was annealed under the same conditions. After as little as one day, the stabilizer used exuded in the form of a white deposit.

Volatility

### EXAMPLE 14

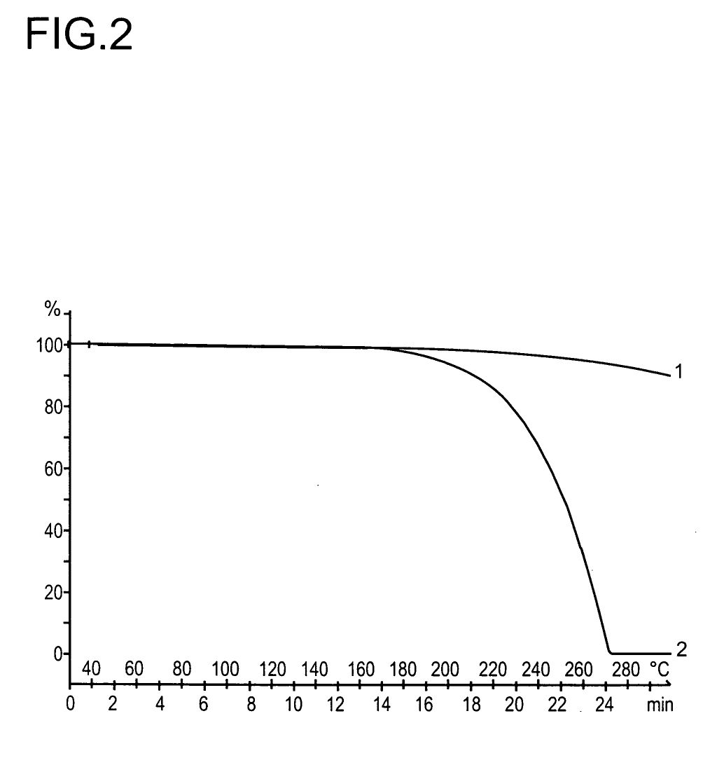

Dimethyl 4-methoxybenzylidenemalonate (Sanduvor® PR25) and the stabilizer from Example 2 were studied for volatility by thermogravimetric analysis. The experiment was carried out with a heating rate of 10 K/min, under an inert gas. The result is illustrated in FIG. 2. FIG. 2 clearly shows that the volatility of the stabilizer from Example 2 (line 1) is markedly lower than the volatility of the commercial product (line 2).

We claim:

1. A substance mixture (I) with a number-average molar mass of from 500 to 15 000 g/mol, where the number-average molar mass is not identical with the weight-average molar mass, obtainable by
A) reacting UV absorbers (II), or a mixture of UV absorbers (II) and stabilizers (III) for plastics, with diols (IV), where at least some of the UV absorbers (II) or of the stabilizers (III) have at least two groups reactive toward diols, or
B) reacting UV absorbers (II), or a mixture of UV absorbers (II) and stabilizers (III) for plastics, with a polyol (V), where the reaction conditions for reaction A) or B) are selected so as to give the substance mixture (I) an aliphatic hydroxyl value below 20.

2. A substance mixture as claimed in claim 1, obtainable by reaction A) or reaction B).

3. A substance mixture as claimed in claim 1 or 2, wherein use is made of a UV absorber of the formula II.1, II.2, or II.3, or of a mixture of these, 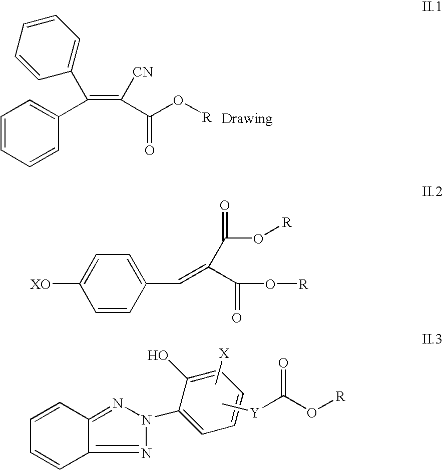
where X is a hydrogen atom, a linear or branched C₁-C₂₀-alkyl radical, a C₅-C₁₂-cycloalkyl radical, where appropriate mono-, di-, or trisubstituted with a C₁-C₂₀-alkyl radical or phenylalkyl radical, or is a hindered amine,
R is a hydrogen atom, a linear or branched C₁-C₁₀-alkyl radical, preferably C₁-C₂-alkyl radical, or a C₁-C₁₀-alkoxyalkyl radical, or a C₁-C₁₀-alkenyl radical, and Y is a covalent bond or a linear or branched C₁-C₁₂-alkylene radical.

4. A substance mixture as claimed in any of claims 1 to 3, wherein the stabilizer used comprises sterically hindered phenols of the formula III.1 or III.3, 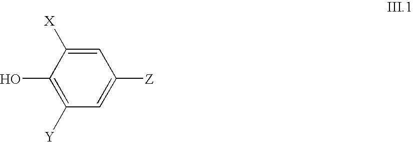
where X and Y, independently of one another, are hydrogen, or straight-chain, branched, or cyclic alkyl radicals having from 1 to 12 carbon atoms, and Z is at least one carboxy group bonded via a C₁-C₁₂-alkylene radical to the phenol radical, or 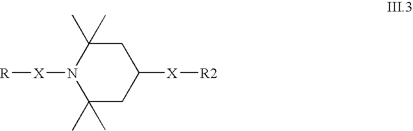
where X is a covalent bond, a nitrogen atom, an oxygen atom, an amide gorup, or an ester group, and R and R2, independently of one another, are a hydrogen atom or an alkyl radical having from 1 to 12 carbon atoms, where at least one of the radicals has at least one functional group, such as a carboxy group, ester group, or an amide group, so that linkage to the diol (IV) or polyol (V) is possible via this functional group.

5. A process for preparing a substance mixture as claimed in claim 1, which comprises reacting UV absorbers (II), or a mixture of UV absorbers (II) and stabilizers (III), with diols (IV), where at least some of the UV absorbers (II) or of the stabilizers (III) have at least two groups reactive toward diols (IV).

6. A process for preparing a substance mixture as claimed in claim 1, wherein UV absorbers (II), or a mixture of UV absorbers (II) and stabilizers (III), are reacted with a polyol (V).

7. The use of the substance mixture as claimed in any of claims 1 to 4 for the UV-stabilization of plastics.

8. A process for preparing polyurethanes by reacting polyisocyanates with compounds reactive toward isocyanates, which comprises using, for the stabilization, a substance mixture as claimed in any of claims 1 to 4.

9. A polyurethane obtainable by a process as claimed in claim 8.
